(19) United States
(12) Patent Application Publication
(10) Pub. No.: US 2020/0074845 A1
(43) Pub. Date: Mar. 5, 2020

(54) REMOTE CONTROL SWITCH FOR ELECTRICAL EQUIPMENT

(71) Applicant: DISCO CORPORATION, Tokyo (JP)

(72) Inventor: Kazuma SEKIYA, Tokyo (JP)

(21) Appl. No.: 16/546,542

(22) Filed: Aug. 21, 2019

(30) Foreign Application Priority Data
Aug. 28, 2018 (JP) 2018-159596

(51) Int. Cl. G08C 17/02; H02K 7/18; F03G 7/00

(52) U.S. Cl. CPC G08C 17/02; F03G 7/00; H02K 7/1853

(57) ABSTRACT

A remote control switch which can eliminate the need for replacement of dry batteries and can be used regardless of the lightness of a use environment is provided. The remote control switch includes a push member adapted to be pushed, thereby moving to perform a push operation, a power generating portion for generating electric power in response to the push operation by the push member, and a communication signal transmitting portion for transmitting a specific communication signal by using the electric power generated from the power generating portion.

### BACKGROUND OF THE INVENTION

### Field of the Invention

The present invention relates to a remote control switch for remotely controlling electrical equipment, a remote control unit having such a remote control switch, and the electrical equipment to be remotely controlled by the remote control switch or the remote control unit.

### Description of the Related Art

In a remote control unit for remotely controlling electrical equipment or the like, a dry battery is generally used as a power source. In the case of using a dry battery as a power source, there is a demerit that the dry battery becomes dead (i.e., the battery voltage becomes less than an operating voltage of the remote control unit), causing a condition that the remote control unit cannot be operated. Further, there is also a demerit that the replacement of dry batteries is required. In particular, in a remote control unit for operating an air conditioner that is not frequently used, the dead condition of the dry battery is hard to notice. Further, in the case that a manual switch for use in turning on an air conditioner is provided on the body of the air conditioner, this manual switch is usually located at a high position where a user's hand is hard to reach. Accordingly, the dead condition of the dry battery in the remote control unit has a large adverse effect. Further, the size of the remote control unit must be increased to form a space for storing the dry battery. There is a method for generating electric power by using a solar battery in place of a dry battery (see Japanese Patent Laid-open No. H5-115085, for example). However, at a place where the lightness is insufficient in generating electric power by using the solar battery, the remote control unit cannot be used. In addition, the remote control unit requires a space for providing a light receiving panel.

### SUMMARY OF THE INVENTION

As described above, the conventional remote control unit has a problem that the replacement of dry batteries is necessary and has another problem that the remote control unit sometimes becomes unusable according to the lightness of a use environment as in the case of using a solar battery.

The present invention has been made in view of such problems, and it is therefore an object of the present invention to provide a remote control switch which can eliminate the need for replacement of dry batteries and can be used regardless of the lightness of a use environment.

In accordance with an aspect of the present invention, there is provided a remote control switch including a push member adapted to be pushed, thereby moving to perform a push operation; a power generating portion for generating electric power in response to the push operation by the push member; and a communication signal transmitting portion for transmitting a specific communication signal by using the electric power generated from the power generating portion.

In accordance with another aspect of the present invention, there is provided a remote control unit having a plurality of remote control switches, each of the remote control switches including a push member adapted to be pushed, thereby moving to perform a push operation; a power generating portion for generating electric power in response to the push operation by the push member; and a communication signal transmitting portion for transmitting a specific communication signal by using the electric power generated from the power generating portion.

In accordance with further aspect of the present invention, there is provided electrical equipment having a receiving portion for receiving a specific communication signal transmitted from a remote control switch, the remote control switch including a push member adapted to be pushed, thereby moving to perform a push operation; a power generating portion for generating electric power in response to the push operation by the push member; and a communication signal transmitting portion for transmitting the specific communication signal by using the electric power generated from the power generating portion.

In the remote control switch according to the present invention, the power generating portion generates electric power in response to the push operation by the push member. Accordingly, unlike the prior art, no dry battery and no solar battery are required in the present invention. That is, there is no need for replacement of dry batteries as in the case of using a dry battery in a remote control unit. Further, it is possible to solve the problem on the lightness of a use environment as in the case of using a solar battery in a remote control unit.

The above and other objects, features, and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a schematic view depicting a remote control switch and an air conditioner according to a first preferred embodiment of the present invention;

FIG. 2A is an elevational view depicting the internal structure of the remote control switch depicted in FIG. 1;

FIG. 2B is a side view for illustrating a mechanical operation of a power generating portion in the remote control switch depicted in FIG. 2A;

FIG. 3 is an elevational view of a remote control unit according to a second preferred embodiment of the present invention;

FIG. 4 is an elevational view of a remote control unit according to a third preferred embodiment of the present invention; and

FIG. 5 is an elevational view of a remote control unit according to a fourth preferred embodiment of the present invention.

### DETAILED DESCRIPTION OF THE PREFERRED EMBODIMENTS

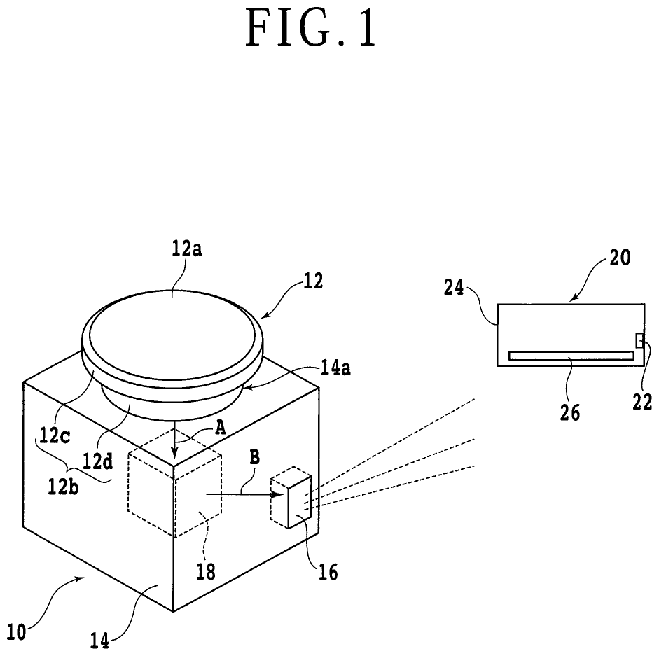

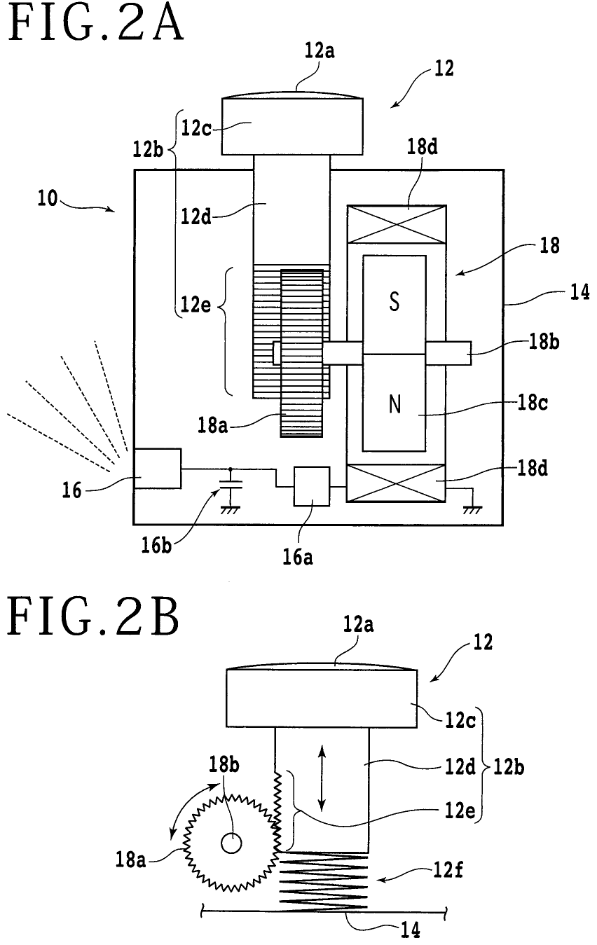

Some preferred embodiments of the present invention will now be described with reference to the attached drawings. FIG. 1 is a schematic view depicting a remote control switch 10 and an air conditioner 20 according to a first preferred embodiment of the present invention. FIG. 2A is an elevational view depicting the internal structure of the remote control switch 10, and FIG. 2B is a side view for illustrating a mechanical operation of a power generating portion 18 in the remote control switch 10. In FIGS. 1, 2A, and 2B, a part of the components is indicated by simplified symbols. The remote control switch 10 is a switch for controlling the operation of the air conditioner 20 as electrical equipment in this preferred embodiment. While the air conditioner 20 is depicted as an example of the electrical equipment to be controlled by the remote control switch 10 in this preferred embodiment, any other examples of the electrical equipment to be controlled by the remote control switch 10 may include illumination equipment, electric fan, and washing machine.

The remote control switch 10 includes a push member 12 adapted to be pushed. The push member 12 includes a push button portion 12a at the top. The push button portion 12a has a size corresponding to the tip of a human finger. The push button portion 12a is formed of resin, for example. The push member 12 further includes a bolt portion 12b formed of metal such as stainless steel. The bolt portion 12b includes a solid-cylindrical head portion 12c bonded to the back side (lower surface) of the push button portion 12a. The bolt portion 12b further includes a solid-cylindrical shaft portion (shank) 12d having a diameter smaller than that of the head portion 12c. The shaft portion 12d extends downward from the lower surface of the head portion 12c. The remote control switch 10 further includes a boxlike housing 14 having a shape like a rectangular prism. The housing 14 is formed of resin, for example. The housing 14 has an upper surface formed with a circular opening 14a for insertion of the shaft portion 12d of the bolt portion 12b. Accordingly, a part of the upper portion of the shaft portion 12d is exposed so as to project from the upper surface of the housing 14. The remaining part of the shaft portion 12d is located inside the housing 14. The bolt portion 12b further includes a toothed portion 12e (see FIG. 2A). The toothed portion 12e is formed on a part of the cylindrical surface of the shaft portion 12d at its lower portion opposite to the head portion 12c. In this preferred embodiment, the toothed portion 12e is composed of a plurality of ridges and grooves alternately arranged in the axial direction of the shaft portion 12d.

The push member 12 further includes a spring portion 12f formed of metal such as stainless steel. The spring portion 12f has an upper end fixed to the lower end of the bolt portion 12b. The spring portion 12f has a lower end fixed to the inside bottom surface of the housing 14 (see FIG. 2B). In FIG. 2A, the spring portion 12f is not depicted for convenience of illustration. When the push button portion 12a of the push member 12 is pushed down by an operator's finger, the bolt portion 12b is lowered from its initial position, so that the spring portion 12f is elastically deformed to be compressed. Thereafter, when a depression force applied to the push member 12 is removed, the spring portion 12f exerts a restoring force and is returned to its initial condition, so that the bolt portion 12b is also returned to its initial position. A gear portion 18a is in mesh with the toothed portion 12e formed on the cylindrical surface of the shaft portion 12d of the bolt portion 12b. The gear portion 18a is a component of the power generating portion 18. The gear portion 18a is rotatable about a horizontal axis perpendicular to the axial direction of the shaft portion 12d, i.e., the direction of vertical movement of the toothed portion 12e.

As depicted n FIGS. 2A and 2B, the gear portion 18a is a general spur gear, and the toothed portion 12e is formed by teeth adapted to mesh with this spur gear. As a modification, the toothed portion 12e may be formed by an external thread having a spiral ridge and a spiral groove. Further, any other gear mechanisms may be adapted as the gear portion 18a and the toothed portion 12e. A horizontal shaft 18b is fixed to the center of rotation of the gear portion 18a. The horizontal shaft 18b is also a component of the power generating portion 18. The horizontal shaft 18b is a solid-cylindrical bar formed of metal such as stainless steel. The horizontal shaft 18b is rotatably supported by bearings (not depicted). Accordingly, a force generated by the vertical movement of the push member 12 is converted into the rotation of the horizontal shaft 18b by the mesh of the toothed portion 12e and the gear portion 18a and the fixation of the horizontal shaft 18b to the gear portion 18a. A permanent magnet 18c is fixed to the horizontal shaft 18b at a portion opposite to the gear portion 18a. The permanent magnet 18c is also a component of the power generating portion 18. The permanent magnet 18c is a solid-cylindrical or ring-shaped permanent magnet coaxially arranged with respect to the horizontal shaft 18b. In this preferred embodiment, the permanent magnet 18c is composed of an N pole forming a circumferential half portion and an S pole forming the remaining half portion. As a modification, the permanent magnet 18c may have four poles, i.e., two N poles and two S poles arranged alternately in the circumferential direction. As another modification, the permanent magnet 18c may have eight poles (four N poles and four S poles arranged alternately) or twelve poles (six N poles and six S poles arranged alternately).

Further, a hollow-cylindrical coil 18d is provided around the permanent magnet 18c so as to surround the cylindrical surface of the permanent magnet 18c. The coil 18d is also a component of the power generating portion 18. The coil 18d is formed by spirally winding a single metal wire (i.e., conductor). The center of winding of the wire forming the coil 18d substantially coincides with the center of rotation of the horizontal shaft 18b. When the permanent magnet 18c is rotated by the rotation of the horizontal shaft 18b, a magnetic flux passing through the coil 18d changes with time, so that an induced electromotive force B (see FIG. 1) is generated from the coil 18d. In this manner, the power generating portion 18 is composed of the gear portion 18a, the horizontal shaft 18b, the permanent magnet 18c, and the coil 18d, all of which are provided in the housing 14. That is, when a push operation A (see FIG. 1) by the operator is performed to vertically move the push member 12, the induced electromotive force B is generated by the power generating portion 18. More specifically, when the push operation A is performed to lower the push member 12, the horizontal shaft 18b is rotated in a forward direction. Thereafter, when the push operation A is canceled, the push member 12 is lifted by the restoring force of the spring portion 12f elastically deformed by the push operation A. Accordingly, the horizontal shaft 18b is automatically rotated in a backward direction opposite to the forward direction (see FIG. 2B).

In particular, a rising speed of the push member 12 by the return operation is prone to become larger than a lowering speed of the push member 12 by the push operation A due to the biasing force of the spring portion 12f. Accordingly, the horizontal shaft 18b is prone to rotate more quickly in the return operation than in the push operation A. As a result, a change in magnetic flux per unit time in the return operation becomes larger than that in the push operation A, so that the induced electromotive force B becomes larger in the return operation. Further, in the case that the spring portion 12f is compressed to the maximum, the biasing force of the spring portion 12f is constant regardless of the lowering speed of the push member 12. Accordingly, the horizontal shaft 18b can be rotated at a constant speed more stably in the return operation than in the push operation A, so that the induced electromotive force B can be obtained more stably in the return operation than in the push operation A. Further, there is a case that the return operation may be followed by vibration (e.g., damped vibration) of the spring portion 12f until it completely comes to rest at the original position and that this vibration may also cause the induced electromotive force B.

One end of the coil 18d for generating the induced electromotive force B is connected to a metal frame (not depicted) provided in the housing 14. That is, one end of the coil 18d is frame-grounded to the metal frame. The other end of the coil 18d is connected to one end of a rectifying portion 16a. The rectifying portion 16a functions to convert an alternating current from the power generating portion 18 into a direct current. For example, the rectifying portion 16a is formed by a single diode. In the case that the rectifying portion 16a is a single diode, the anode of the diode corresponds to one end of the rectifying portion 16a, and this anode is connected to the other end of the coil 18d. As a modification, the rectifying portion 16a may be a full-wave rectification type bridge diode formed by four diodes packaged as a unit. The other end of the rectifying portion 16a is connected to a first electrode of a charging portion 16b, in which the first electrode is at a higher potential. The current rectified by the rectifying portion 16a is output to the first electrode of the charging portion 16b. In this preferred embodiment, the charging portion 16b is a capacitor having the first electrode mentioned above and a second electrode opposed to the first electrode, in which the second electrode is at a lower potential. The second electrode of the charging portion 16b is frame-grounded to the metal frame in the housing 14.

A communication signal transmitting portion 16 is connected to the first electrode of the charging portion 16b. The communication signal transmitting portion 16 functions to transmit a specific communication signal for controlling the operation of the air conditioner 20 by radio. The communication signal transmitting portion 16 is provided in the housing 14 in such a manner that a part of the communication signal transmitting portion 16 is exposed to one side surface of the housing 14 (see FIGS. 1 and 2A). When the charging portion 16b is operated to charge the electric power generated from the power generating portion 18 and the potential difference between the first electrode and the second electrode of the charging portion 16b becomes a predetermined voltage value or more that can start the operation of the communication signal transmitting portion 16, the communication signal transmitting portion 16 transmits the specific communication signal to the air conditioner 20. The communication signal to be transmitted from the communication signal transmitting portion 16 to the air conditioner 20 is a signal specific to the remote control switch 10. For example, the communication signal is configured by a communication format using infrared radiation (IR). As a modification, the communication signal may be configured by a communication format using radio frequency (RF) that can be transmitted by a lower power as compared with the case of using infrared radiation.

In this manner, the communication signal transmitting portion 16 transmits the communication signal by using the electric power generated from the power generating portion 18. As described above, one push of the push button portion 12a causes the push operation A and the return operation constituting a reciprocating operation, thereby obtaining the electric power having a predetermined voltage value or more that can start the operation of the communication signal transmitting portion 16. If the above electric power having a predetermined voltage value or more for starting the operation of the communication signal transmitting portion 16 cannot be obtained by the above reciprocating operation because of any trouble in the mechanical operation of the power generating portion 18, the push button portion 12a may be pushed twice or more. As a result, the electric power having a predetermined voltage value or more is charged in the charging portion 16b, and the communication signal is then transmitted from the communication signal transmitting portion 16. The air conditioner 20 has a receiving portion 22 for receiving the communication signal transmitted from the remote control switch 10 (see FIG. 1). As depicted in FIG. 1, the air conditioner 20 has a housing 24, and the receiving portion 22 is provided in the housing 24 so as to be exposed to the front side thereof.

When the receiving portion 22 of the air conditioner 20 receives the communication signal from the remote control switch 10, the air conditioner 20 starts operating according to the signal specific to the remote control switch 10. More specifically, in the case that the power to the air conditioner 20 is off, the air conditioner 20 is started by once receiving the communication signal and then operated in an operation mode previously selected, such as a cooling mode or a heating mode. Further, when the receiving portion 22 of the air conditioner 20 receives the communication signal from the remote control switch 10, the air conditioner 20 changes the operation mode according to a signal specific to the remote control switch 10. More specifically, in the case that the power to the air conditioner 20 is on, the operation mode of the air conditioner 20 is changed by once receiving the communication signal. As a modification, the air conditioner 20 may be started by once receiving the communication signal, and the operation mode of the air conditioner 20 may be changed by continuously twice or more (e.g. twice) receiving the communication signal. Accordingly, both the start of the air conditioner 20 and the change of the operation mode can be effected by using only the remote control switch 10. The air conditioner 20 has an air vent 26 formed on the front side of the housing 24 at a lower portion thereof. The air vent 26 of the air conditioner 20 functions to blow a cool air or a warm air according to the operation mode. The air vent 26 is provided with a first wing (not depicted) for vertically adjusting the direction of air flow and a second wing (not depicted) for horizontally adjusting the direction of air flow.

The flow of the operation of the remote control switch 10 as from the push operation A to the transmission of the communication signal will now be described in brief. When the push button portion 12a of the push member 12 is pushed by an operator's finger (i.e., the push operation A is performed), so as to operate the air conditioner 20, the mechanical cooperative operation of the toothed portion 12e and the gear portion 18a is effected to rotate the permanent magnet 18c. As a result, electric power is charged in the charging portion 16b. When a predetermined potential difference is obtained between the first electrode and the second electrode of the charging portion 16b, a communication signal for operating the air conditioner 20 is transmitted from the communication signal transmitting portion 16 to the air conditioner 20. The air conditioner 20 having received the communication signal starts the operation or changes the operation mode according to the signal specific to the remote control switch 10.

In the remote control switch 10 according to the first preferred embodiment, the power generating portion 18 generates electric power in response to the push operation A of the push member 12, so that the replacement of dry batteries is unnecessary. In addition, no solar battery is provided in the remote control switch 10, so that the remote control switch 10 can be used regardless of the lightness in a use environment, and the light receiving space of a solar battery can also be eliminated. While the power generating portion 18 generates electric power by using electromagnetic induction in this preferred embodiment, the power generation mechanism of the power generating portion 18 is not limited to electromagnetic induction. For example, the power generating portion 18 may be a piezoelectric element capable of inducing an electric charge by receiving a pressure.

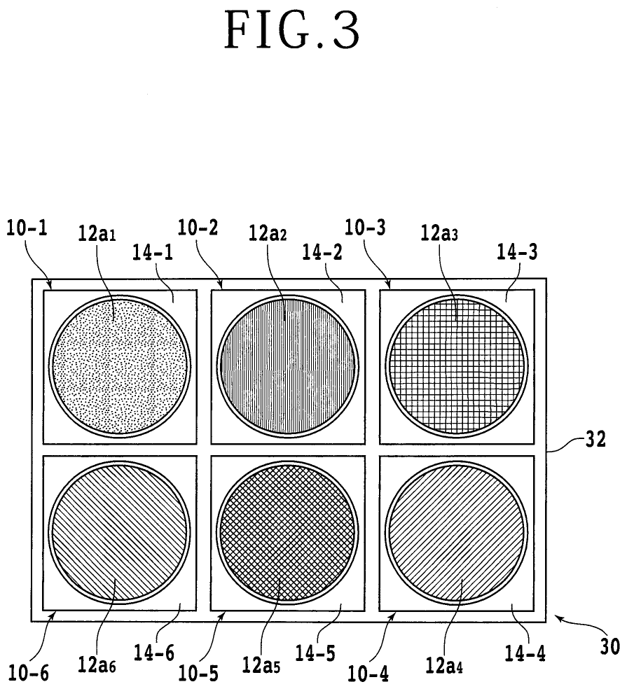

There will now be described a second preferred embodiment of the present invention with reference to FIG. 3. FIG. 3 is an elevational view of a remote control unit 30 having a plurality of remote control switches 10 packaged as a unit according to the second preferred embodiment. As depicted in FIG. 3, the remote control unit 30 includes a plurality of remote control switches 10-1, 10-2, 10-3, 10-4, 10-5, and 10-6. Each of the remote control switches 10-1, 10-2, 10-3, 10-4, 10-5, and 10-6 has a structure similar to that of the remote control switch 10 according to the first preferred embodiment. However, different communication signals are transmitted from communication signal transmitting portions 16 respectively included in the remote control switches 10-1 to 10-6 to the electrical equipment. While the remote control unit 30 includes the six remote control switches 10 in the second preferred embodiment, the number of the plural remote control switches 10 in the remote control unit 30 is not limited. The remote control unit 30 has a rectangular switch case 32. The switch case 32 has six rectangular recesses for respectively storing six housings 14-1, 14-2, 14-3, 14-4, 14-5, and 14-6. That is, the remote control switches 10-1, 10-2, 10-3, 10-4, 10-5, and 10-6 have the housings 14-1, 14-2, 14-3, 14-4, 14-5, and 14-6, respectively. The six rectangular recesses of the switch case 32 are arranged like a matrix with 2 rows and 3 columns (or a matrix with 3 rows and 2 columns). Thus, the housings 14-1 to 14-6 of the remote control switches 10-1 to 10-6 are separately stored in the switch case 32 of the remote control unit 30. The arrangement of the plural recesses formed in the switch case 32 is merely illustrative.

Each of the housings 14-1 to 14-6 may have an opening for exposing a metal frame for frame grounding. For example, the switch case 32 has a frame, and a metal plate for common frame grounding is provided on this frame of the switch case 32. The metal frame of each housing 14 is electrically connected to the metal plate provided on the frame of the switch case 32. The plural remote control switches 10-1 to 10-6 have different functions for operating the air conditioner 20. For example, the remote control switch 10-1 transmits a communication signal for turning on and off the air conditioner 20, the remote control switch 10-2 transmits a communication signal for selecting a cooling mode, and the remote control switch 10-3 transmits a communication signal for selecting a heating mode.

Further, the remote control switch 10-4 transmits a communication signal for selecting a dehumidifying mode, the remote control switch 10-5 transmits a communication signal for raising a set temperature by 0.5° C. from a current set temperature, and the remote control switch 10-6 transmits a communication signal for lowering a set temperature by 0.5° C. from a current set temperature. The remote control switches 10-1, 10-2, 10-3, 10-4, 10-5, and 10-6 have push button portions 12a₁, 12a₂, 12a₃, 12a₄, 12a₅, and 12a₆, respectively, in which these push button portions 12a₁ to 12a₆ have different patterns according to the difference in function among the remote control switches 10-1 to 10-6 as depicted in FIG. 3. As a modification, the push button portions 12a₁ to 12a₆ may have different sizes in addition to the different patterns. Further, each of the push button portions 12a₁ to 12a₆ may be provided with characters or symbols, for example.

In this preferred embodiment, a user of the remote control unit 30 can freely customize the layout of the remote control switches 10-1 to 10-6 in the switch case 32. Furthermore, the user can arbitrarily change the number and kind of the remote control switches 10-1 to 10-6. Accordingly, the remote control unit 30 can be changed in configuration in such a manner that any push button portion unnecessary for the user has been eliminated from the push button portions 12a₁ to 12a₆. Further, an additional remote control switch 10 for operating other electrical equipment may be provided in the switch case 32 in addition to the remote control switches 10 for operating the air conditioner 20. In this case, a plurality of pieces of electrical equipment can be operated by the single remote control unit 30.

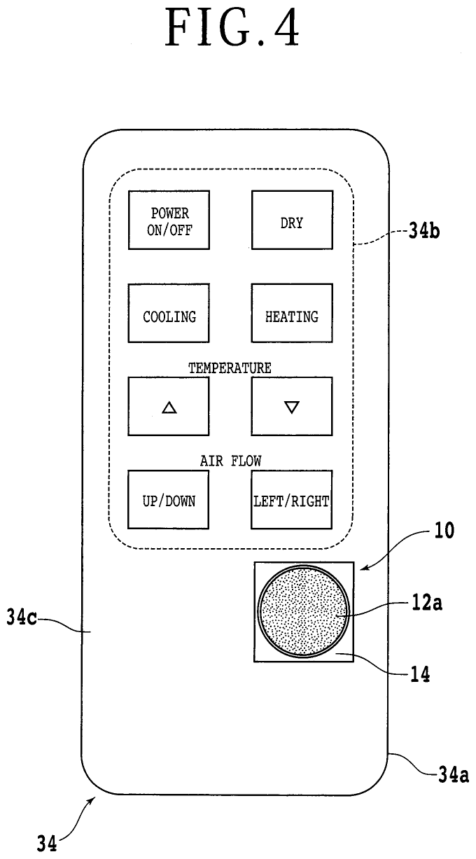

There will now be described a third preferred embodiment of the present invention with reference to FIG. 4. FIG. 4 is an elevational view of a remote control unit 34 according to the third preferred embodiment. As depicted in FIG. 4, the remote control unit 34 includes a housing 34a and the remote control switch 10 according to the first preferred embodiment, in which the housing 34a is a housing of a usual commercially available remote control unit. The remote control unit 34 has a set of various operation buttons 34b including power on/off button, dehumidifying mode (dry mode) button, cooling mode button, heating mode button, temperature raising button, temperature lowering button, air flow up/down button, and air flow right/left button. A dry battery is mounted in the remote control unit 34. When any one of these operation buttons is depressed, a specific communication signal is transmitted to the air conditioner 20 by the power of the dry battery.

The housing 34a of the remote control unit 34 has a front surface 34c. The set of various operation buttons 34b mentioned above is provided on the front surface 34c of the housing 34a, and the remote control switch 10 is also provided on the front surface 34c at a position different from the position where the set of various operation buttons 34b is provided. The remote control switch 10 in this preferred embodiment is an emergency remote control switch for use in the case that the dry battery in the remote control unit 34 is dead and the air conditioner 20 is to be started quickly before replacing the dry battery. The remote control switch 10 in this preferred embodiment has a function of transmitting to the air conditioner 20 a communication signal corresponding to the starting of the air conditioner 20 (i.e., the operation of turning on the air conditioner 20). As described above, in the remote control switch 10, electric power can be generated by the push operation A of the push member 12. Accordingly, even when the dry battery in the remote control unit 34 is dead, the air conditioner 20 can be started by the remote control switch 10. Thus, by adding the remote control switch 10, the convenience to use of the remote control unit 34 can be remarkably improved.

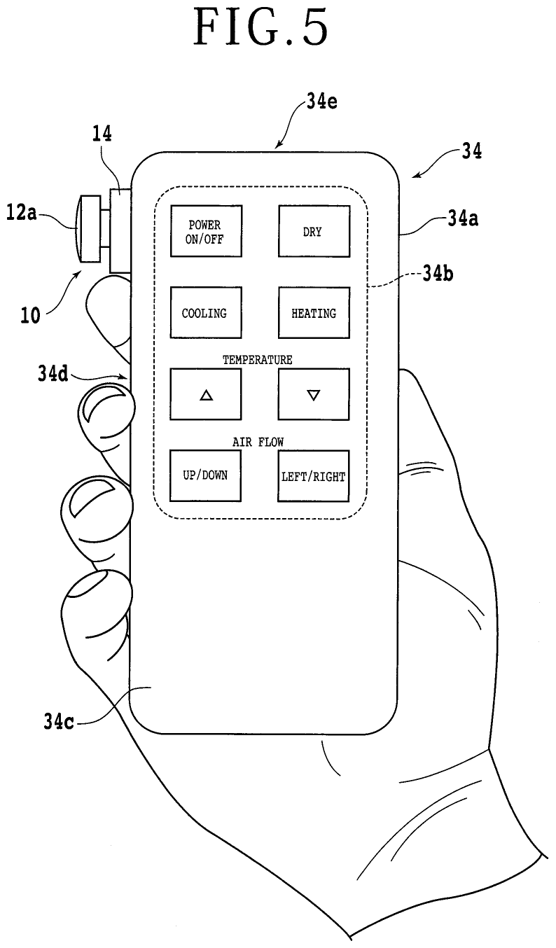

The remote control switch 10 may be provided on a side surface of the housing 34a rather than on the front surface 34c as described below. FIG. 5 is an elevational view of a remote control unit 34 according to a fourth preferred embodiment of the present invention, in which the housing 34a of the remote control unit 34 has a side surface 34d, and the remote control switch 10 is provided on the side surface 34d of the housing 34a. As depicted in FIG. 4, the remote control unit 34 is grasped by a user's right hand in such a manner that the back side of the housing 34a comes into contact with the palm of the right hand. In this case, the remote control switch 10 is provided at the position corresponding to the forefinger of the right hand. As s modification, the remote control switch 10 may be provided at the position corresponding to the thumb of the right hand rather than the position corresponding to the forefinger of the right hand. Further, the remote control switch 10 may be provided at the position corresponding to any one of the other fingers.

In this manner, the remote control unit 34 is usually grasped by the hand in operating the air conditioner 20. Accordingly, by providing the remote control switch 10 on the side surface 34d of the housing 34a at the position corresponding to any one of the fingers, the convenience to use of the remote control unit 34 can be improved. Further, in the case of intentionally using the remote control switch 10 rather than the power on/off button provided in the set of various operation buttons 34b in starting the air conditioner 20, the consumption of the dry battery mounted in the remote control unit 34 can be suppressed. The housing 34a has an upper surface 34e as depicted in FIG. 5. As a modification, the remote control switch 10 may be provided on the upper surface 34e of the housing 34a rather than on the side surface 34d of the housing 34a. That is, the remote control switch 10 may be provided at the position where the hand does not usually come into contact. In this case, it is possible to prevent that the remote control switch 10 may be erroneously depressed.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A remote control switch comprising:
a push member adapted to be pushed, thereby moving to perform a push operation;
a power generating portion for generating electric power in response to the push operation by the push member; and
a communication signal transmitting portion for transmitting a specific communication signal by using the electric power generated from the power generating portion.

2. A remote control unit having a plurality of remote control switches, each of the remote control switches comprising:
a push member adapted to be pushed, thereby moving to perform a push operation;
a power generating portion for generating electric power in response to the push operation by the push member; and
a communication signal transmitting portion for transmitting a specific communication signal by using the electric power generated from the power generating portion.

3. Electrical equipment having a receiving portion for receiving a specific communication signal transmitted from a remote control switch, the remote control switch comprising:
a push member adapted to be pushed, thereby moving to perform a push operation;
a power generating portion for generating electric power in response to the push operation by the push member; and
a communication signal transmitting portion for transmitting the specific communication signal by using the electric power generated from the power generating portion.
